(19) United States
(12) Patent Application Publication
(10) Pub. No.: US 2026/0363486 A1
(43) Pub. Date: Nov. 19, 2026

(54) DESKTOP FOOD DISTRIBUTION DEVICE

(71) Applicant: YINDU KITCHEN EQUIPMENT CO., LTD., Hangzhou (CN)

(72) Inventor: Junjie ZHOU, Hangzhou (CN)

(73) Assignee: YINDU KITCHEN EQUIPMENT CO., LTD., Hangzhou (CN)

(21) Appl. No.: 19/284,755

(22) Filed: Jul. 30, 2025

(30) Foreign Application Priority Data
May 16, 2025 (CN) 202510635323.6

(51) Int. Cl. A47J 37/12

(52) U.S. Cl. CPC A47J 37/1228; A47J 37/1219

(57) ABSTRACT

The provided is a desktop food distribution device. The desktop food distribution device includes a housing, a carrying platform, a storage bin assembly, a bin carrying member, a weighing assembly, lift assemblies, and a door switching assembly, where the carrying platform is arranged in the housing; the weighing assembly is arranged on the carrying platform; the lift assemblies are arranged on the carrying platform; the lift assemblies are located on an outer side of the weighing assembly; the lift assemblies are connected to a bottom of the bin carrying member; the bin carrying member is located above the weighing assembly; the storage bin assembly is arranged on the bin carrying member; and the lift assemblies can drive the bin carrying member to move upward/downward.

### CROSS-REFERENCE TO THE RELATED APPLICATIONS

This application is based upon and claims priority to Chinese Patent Application No. 202510635323.6, filed on May 16, 2025, the entire contents of which are incorporated herein by reference.

### TECHNICAL FIELD

The present disclosure relates to the technical field of desktop food distribution devices, and specifically to a desktop food distribution device.

### BACKGROUND

The frozen food distributor is a device configured to quickly take out the frozen food that needs to be processed or used from the distributor according to the required weight or volume. It improves labor efficiency and reduces labor intensity, and is applied in canteens, restaurants, and catering chains, etc.

The current frozen food distributors on the market are all vertical-type. The vertical food distributors take up a large amount of space, and the upper space cannot be utilized. Moreover, the storage bin on the prior food distributor is always pressed against the load cell, which will cause impacts to the load cell when loading, thereby resulting in a reduction in the service life of the load cell.

### SUMMARY

The objective of the present disclosure is to provide a desktop food distribution device to solve the technical problem of low service life of load cells in the prior art.

In a first aspect, the embodiments of the present disclosure provide a desktop food distribution device, including a housing, a carrying platform, a storage bin assembly, a bin carrying member, a weighing assembly, and lift assemblies;
the carrying platform is arranged in the housing; the weighing assembly is arranged on the carrying platform;
the lift assemblies are arranged on the carrying platform; the lift assemblies are located on an outer side of the weighing assembly; the lift assemblies are connected to a bottom of the bin carrying member; the bin carrying member is located above the weighing assembly; the storage bin assembly is arranged on the bin carrying member; the lift assemblies can drive the bin carrying member to move upward/downward, so that the bin carrying member can detach from the weighing assembly.

In conjunction with the first aspect, the embodiments of the present disclosure provide a possible implementation of the first aspect, wherein the weighing assembly includes a plurality of load cells; the plurality of load cells are arranged on the carrying platform; and
the bin carrying member includes a support frame, and a bin carrying platform configured for carrying the storage bin assembly, wherein the bin carrying platform is arranged on the support frame; the support frame is arranged on the plurality of load cells; the support frame is provided with a weighing push rod capable of abutting against the load cells; a plurality of lift assemblies are connected to a bottom of the support frame; and the lift assemblies can lift the support frame away from the load cells.

In conjunction with the first aspect, the embodiments of the present disclosure provide a possible implementation of the first aspect, wherein each of the lift assemblies includes a lift driving member and a lift push rod; the lift driving member is arranged on the carrying platform; the lift push rod is in transmission connection with the lift driving member; and the lift push rod is connected to a bottom of the support frame;
the lift driving member includes a lift motor, a lift transmission member, and a lift guide sleeve; the lift motor is mounted on the carrying platform; the lift transmission member is arranged on an output end of the lift motor; the lift transmission member is in transmission connection with the lift push rod; the lift guide sleeve is arranged in the carrying platform; the lift push rod is inserted in the lift guide sleeve; and one end of the lift push rod away from the lift transmission member can pass through the lift guide sleeve to connect to a bottom of the support frame; and
the lift motor is provided with a lift motor mounting plate, and the lift motor mounting plate is arranged on the carrying platform.

In conjunction with the first aspect, the embodiments of the present disclosure provide a possible implementation of the first aspect, wherein a lift reset spring is arranged between the lift push rod and the lift guide sleeve; the lift reset spring is sleeved on the lift push rod; and the lift push rod is provided with a step abutting against the lift reset spring; and
the lift transmission member includes a lift cam; the lift cam is arranged on the output end of the lift motor; and the lift cam abuts against the lift push rod.

In conjunction with the first aspect, the embodiments of the present disclosure provide a possible implementation of the first aspect, wherein the desktop food distribution device further includes a door switching assembly; the door switching assembly is arranged on the carrying platform; the door switching assembly is located below the weighing assembly; and the door switching assembly includes a food temporary-storage box, a switching door, and a switching driving assembly;
the food temporary-storage box is arranged above the carrying platform, wherein one end of the switching door is pivotally connected to a bottom of the carrying platform, and the other end is in transmission connection with the switching driving assembly;
the switching driving assembly includes a switching driving member and a switching closing member, wherein the switching driving member is arranged on the carrying platform; the switching closing member is arranged on the switching driving member; and the switching closing member is connected to the switching door;
a switching adapter plate is fixedly arranged on an end part of the switching door; one end of the switching adapter plate is pivotally connected to the carrying platform, and the other end is provided with a switching rotation stop pin; the switching rotation stop pin is in transmission connection with the switching driving member, so that the switching rotation stop pin can drive the switching door to rotate under driven of the switching adapter plate; and
the switching adapter plate is provided with a switching rotation pin; the switching rotation pin is rotatably arranged on the carrying platform; and the switching adapter plate is in L-shape.

In conjunction with the first aspect, the embodiments of the present disclosure provide a possible implementation of the first aspect, wherein the above switching driving member includes a switching motor, a switching rack, and a switching drive shaft;
the switching motor is arranged on the carrying platform; the switching rack is slidably arranged on the carrying platform; an output end of the switching motor is provided with a first switching driving gear adapted to the switching rack; the switching drive shaft is rotatably arranged on the carrying platform; and an end part of the switching drive shaft is provided with a second switching driving gear adapted to the switching rack;
the switching drive shaft is provided with a switching toggle rod, and the switching toggle rod abuts against the switching rotation stop pin; and
the switching drive shaft includes a first switching drive shaft and a second switching drive shaft; the switching door includes a first switching door and a second switching door; the first switching drive shaft and the second switching drive shaft respectively correspond to the first switching door and the second switching door; the first switching drive shaft and the second switching drive shaft are both provided with the second switching driving gear; and a slave turning switching gear is arranged between the second switching driving gear of the first switching drive shaft and the switching rack.

In conjunction with the first aspect, the embodiments of the present disclosure provide a possible implementation of the first aspect, wherein the switching closing member includes a switching pressure plate, a switching compression spring, and a switching compression spring bolt;
the switching pressure plate is fixedly arranged on the switching drive shaft; the switching pressure plate is provided with a switching waist slot; and the switching compression spring bolt is arranged in the switching waist slot; and
the switching compression spring bolt is connected to a bottom of the switching door; the switching compression spring is sleeved on the switching compression spring bolt; one end of the switching compression spring abuts against the switching door, and the other end abuts against the switching pressure plate.

In conjunction with the first aspect, the embodiments of the present disclosure provide a possible implementation of the first aspect, wherein the storage bin assembly includes a storage bin body and a discharge wheel; the storage bin body is detachably mounted on the bin carrying member; an inlet port is arranged on the top of the storage bin body; an outlet port is arranged on a bottom of the storage bin body; the bin carrying platform is provided with a drop port corresponding to the outlet port;
the support frame is provided with a discharge power member, wherein the discharge power member can be in transmission connection with the discharge wheel, and the discharge power member is detachably connected to the discharge wheel; and
the discharge wheel is arranged in the storage bin body; two ends of the discharge drive shaft of the discharge wheel are arranged to penetrate through side walls of the storage bin body; one end of the discharge drive shaft is provided with a discharge abutting port that can be adapted to the discharge power member; the other end of the discharge drive shaft is provided with a correction knob; and an angle of the discharge abutting port can be adjusted by rotating the correction knob, so as to dock with the discharge power member.

In conjunction with the first aspect, the embodiments of the present disclosure provide a possible implementation of the first aspect, wherein the discharge power member includes a discharge driving motor and a discharge output shaft;
the discharge driving motor is arranged on the support frame; the discharge output shaft is in transmission connection with the discharge driving motor; the discharge output shaft can be in transmission connection with the discharge drive shaft; and a discharge driving plug for adapting to the discharge abutting port is arranged on a front end of the discharge output shaft.

In conjunction with the first aspect, the embodiments of the present disclosure provide a possible implementation of the first aspect, wherein a flexible baffle is arranged on a side wall of the storage bin body; the flexible baffle is arranged on two sides of the discharge wheel; and the discharge wheel and the flexible baffle wheel divide an internal space of the storage bin body into a storage region and a discharge region; and
the side wall of the storage bin body is provided with a baffle through hole for the flexible baffle to pass through; the side wall of the storage bin body is provided with a recessed baffle mounting base; and the baffle through hole is arranged in the baffle mounting base, so that an extension direction of the flexible baffle faces toward the discharge wheel.

The present disclosure includes the following beneficial effects.

The embodiments of the present disclosure provide a desktop food distribution device, including a housing, a carrying platform, a storage bin assembly, a bin carrying member, a weighing assembly, and lift assemblies, wherein the carrying platform is arranged in the housing; the weighing assembly is arranged on the carrying platform; the lift assemblies are arranged on the carrying platform; the lift assemblies are located on an outer side of the weighing assembly; the lift assemblies are connected to a bottom of the bin carrying member; the bin carrying member is located above the weighing assembly; the storage bin assembly is arranged on the bin carrying member; and the lift assemblies can drive the bin carrying member to move upward/downward, so that the bin carrying member can detach from the weighing assembly.

Specifically, when using the desktop food distribution device, the staff pour the frozen food into the storage bin assembly, or the staff remove the storage bin assembly for maintenance. During the process, it is easy to damage the load cell of the weighing assembly. By providing the lift assembly, the lift assemblies are used to lift the bin carrying member before operating the storage bin assembly, so that the storage bin assembly located on the bin carrying member is detached from the weighing assembly, so as to reduce the impact damage of the storage bin assembly on the weighing assembly, and to increase the service life of the load cell.

### BRIEF DESCRIPTION OF THE DRAWINGS

In order to more clearly illustrate the technical solutions in the embodiments of the present disclosure or in the prior art, the drawings to be used in the description of the embodiments or prior art will be briefly introduced below. It is obvious that the drawings in the following description are some embodiments of the present disclosure. For a person of ordinary skill in the art, other drawings can be obtained based on these drawings without inventive efforts.

FIG. 1 shows an overall schematic diagram of a desktop food distribution device provided by the embodiment of the present disclosure;

FIG. 2 shows a sectional diagram of a desktop food distribution device provided by the embodiments of the present disclosure;

FIG. 3 shows an internal schematic diagram of a desktop food distribution device provided by the embodiments of the present disclosure;

FIG. 4 shows a schematic diagram of a storage bin body in a desktop food distribution device provided by the embodiments of the present disclosure;

FIG. 5 shows a sectional diagram of a storage bin assembly in a desktop food distribution device provided by the embodiments of the present disclosure;

FIG. 6 shows a bottom view of a desktop food distribution device provided by the embodiments of the present disclosure;

FIG. 7 shows a connection schematic diagram of a weighing assembly and a support frame in a desktop food distribution device provided by the embodiments of the present disclosure;

FIG. 8 shows a connection schematic diagram of a lift assembly and a support frame in a desktop food distribution device provided by the embodiments of the present disclosure;

FIG. 9 shows a schematic diagram of a lift assembly in a desktop food distribution device provided by the embodiments of the present disclosure;

FIG. 10 shows a sectional diagram of a lift assembly in a desktop food distribution device provided by the embodiments of the present disclosure;

FIG. 11 shows a structure schematic diagram of a door switching assembly in a desktop food distribution device provided by the embodiments of the present disclosure;

FIG. 12 shows a schematic diagram of a door switching assembly in a desktop food distribution device provided by the embodiments of the present disclosure;

FIG. 13 shows a schematic diagram of a switching driving member of a door switching assembly in a desktop food distribution device provided by the embodiments of the present disclosure;

FIG. 14 shows a schematic diagram of a switching closing member of a door switching assembly in a desktop food distribution device provided by the embodiments of the present disclosure; and

FIG. 15 shows a schematic diagram of a desktop food distribution device used in conjunction with a frying device provided by the present disclosure.

### Reference Numbers

10—housing; 20—carrying platform; 30—discharge power member; 31—discharge driving motor; 32—discharge output shaft; 33—discharge driving plug; 40—robot; 50—frying device; 60—mesh basket;
100—storage bin assembly; 101—storage region; 102—discharge region; 110—storage bin body; 111—inlet port; 112—outlet port; 113—flexible baffle; 114—baffle through hole; 115—baffle mounting base; 120—discharge wheel; 130—discharge drive shaft; 131—discharge abutting port; and 132—correction knob;
200—bin carrying member; 210—support frame; 211—weighing push rod; 220—bin carrying platform; 221—drop port; 222—inclined support platform; 223—bin limit stop pin;
300—weighing assembly; 310—load cell;
400—lift assembly; 410—lift driving member; 411—lift motor; 412—lift transmission member; 413—lift guide sleeve; 414—lift motor mounting plate; 415—lift reset spring; 416-lift cam; 420—lift push rod;
500—door switching assembly; 510—food temporary-storage box; 520—switching door; 521—switching adapter plate; 522—switching rotation stop pin; 523—switching rotation pin; 524—first switching door; 525—second switching door; 530—switching driving assembly; 540—switching driving member; 541—switching motor; 542—switching rack; 543—switching drive shaft; 544—first switching driving gear; 545—second switching driving gear; 546—switching toggle rod; 547—slave turning switching gear; 550—switching closing member; 551—switching pressure plate; 552—switching compression spring; 553—switching compression spring bolt; 554—switching waist slot.

### DETAILED DESCRIPTION OF THE EMBODIMENTS

The technical solutions in the embodiments of the present disclosure will be clearly and completely described below in conjunction with the drawings in the embodiments of the present disclosure. It is obvious that the embodiments described are partial embodiments of the present disclosure, and not all of the embodiments. Based on the embodiments in the present disclosure, all other embodiments obtained by a person of ordinary skill in the art without inventive efforts shall fall within the scope of protection of the present disclosure.

In the description of the present disclosure, it is to be understood that orientation or positional relationships indicated by terms, such as “center”, “longitudinal”, “transverse”, “length”, “width”, “thickness”, “up”, “down”, “front”, “back”, “left”, “right”, “vertical”, “horizontal”, “top”, “bottom” “inside”, “outside”, “clockwise”, “counterclockwise”, “axial”, “radial”, and “circumferential” are the orientation or positional relationships based on the drawings, which are only to facilitate the description of the present disclosure and simplify the description, and are not to indicate or imply that the device or element referred to must have a particular orientation, or be constructed and operated with a particular orientation, and are not to be understood as limitations of the present disclosure.

Additionally, the terms of “first” and “second” are used only for descriptions and are not to be understood as indicating or implying a relative importance or implicitly specifying the number of technical features indicated. Therefore, a feature defined by “first” or “second” can expressly or implicitly include one or more such features. In the description of the present disclosure, “plurality” means two or more, unless otherwise expressly and specifically limited.

In the present disclosure, unless other expressly specifications and limitations, the terms “mount”, “connect”, and “link” are to be understood in a broad sense, e.g. it can be a fixed connection, a detachable connection, or can be integral; it can be a mechanical connection or an electrical connection; it can be a direct connection, an indirect connection through an intermediate medium; and it can be a communication inside two components or interaction relationships between two components. For a person of ordinary skill in the art, the specific meaning of the above terms in the present disclosure may be understood according to specific situations.

The present disclosure is described in further detail below by specific embodiments in conjunction with drawings.

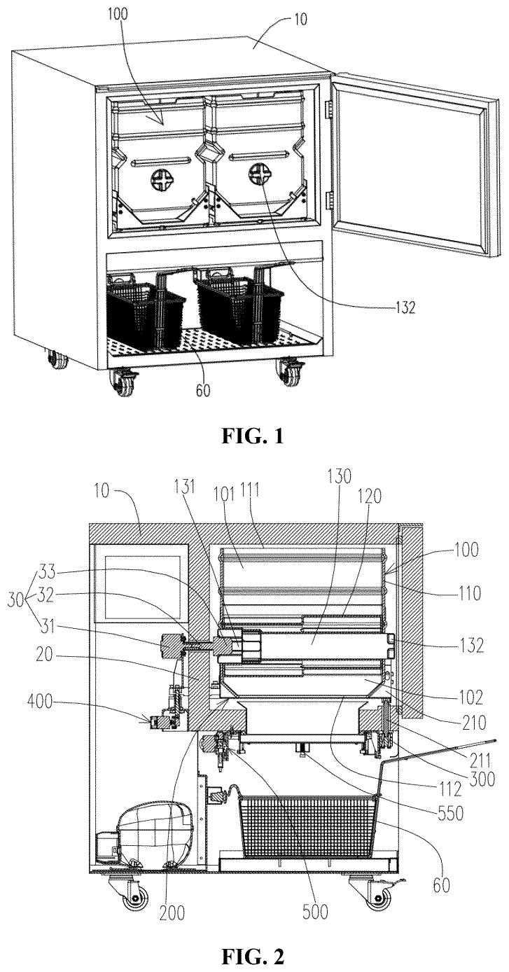

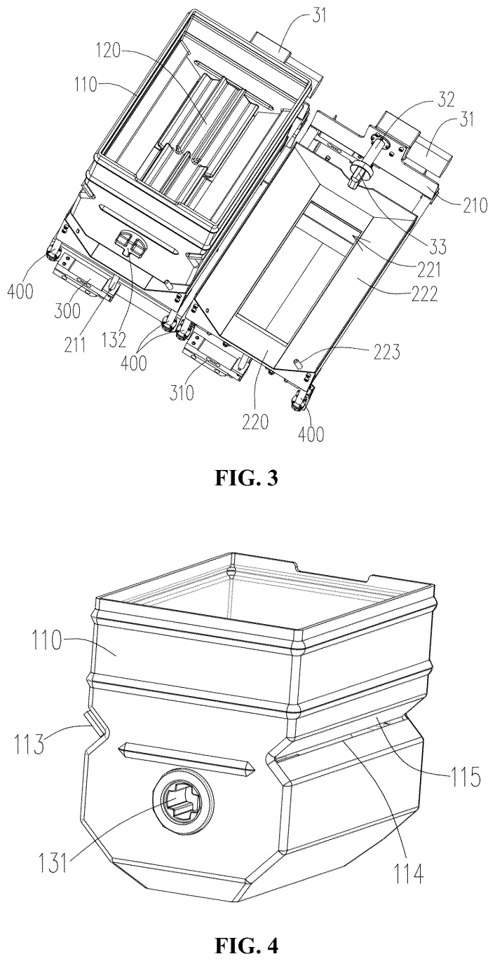

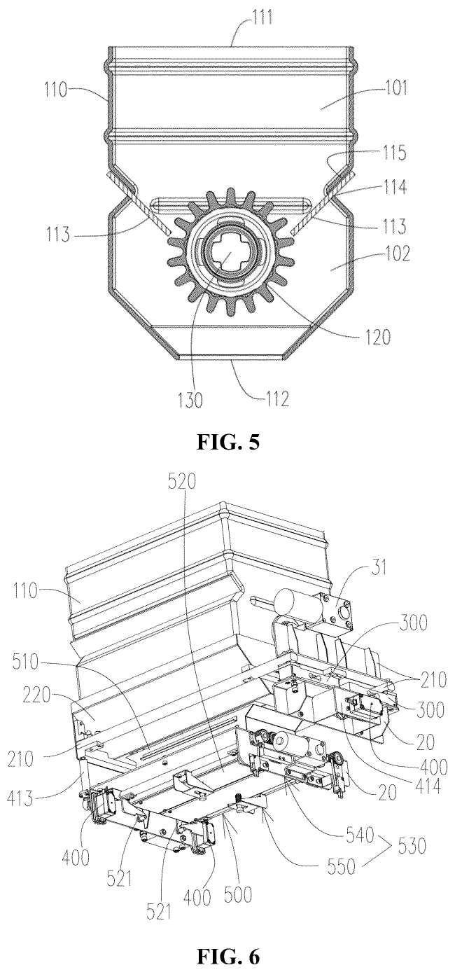

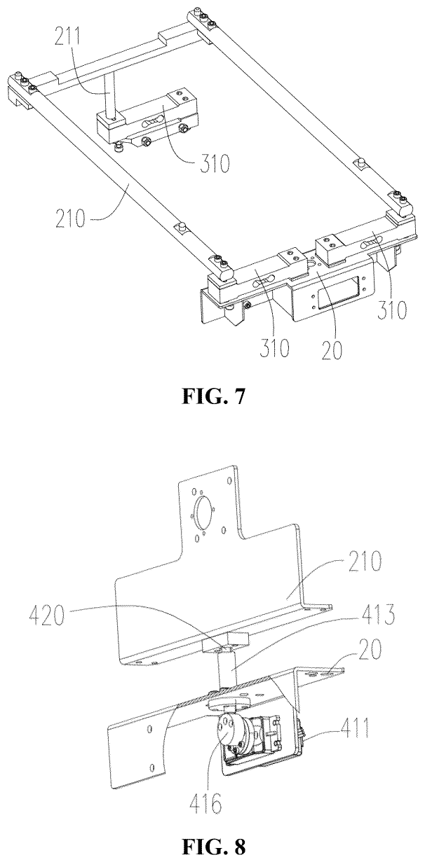

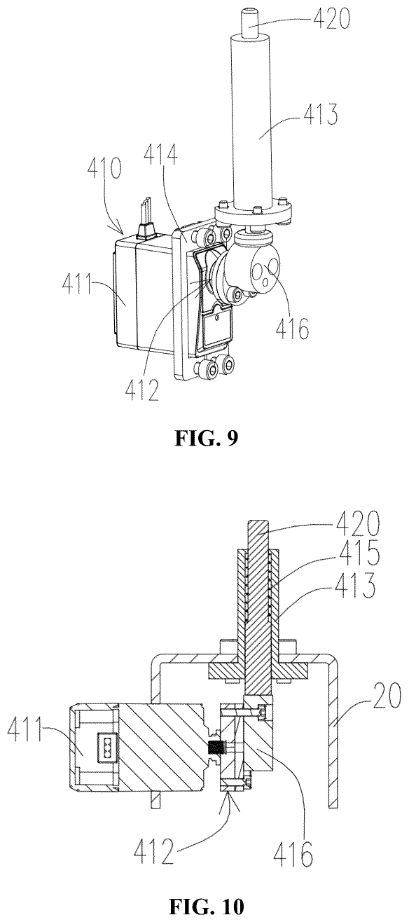

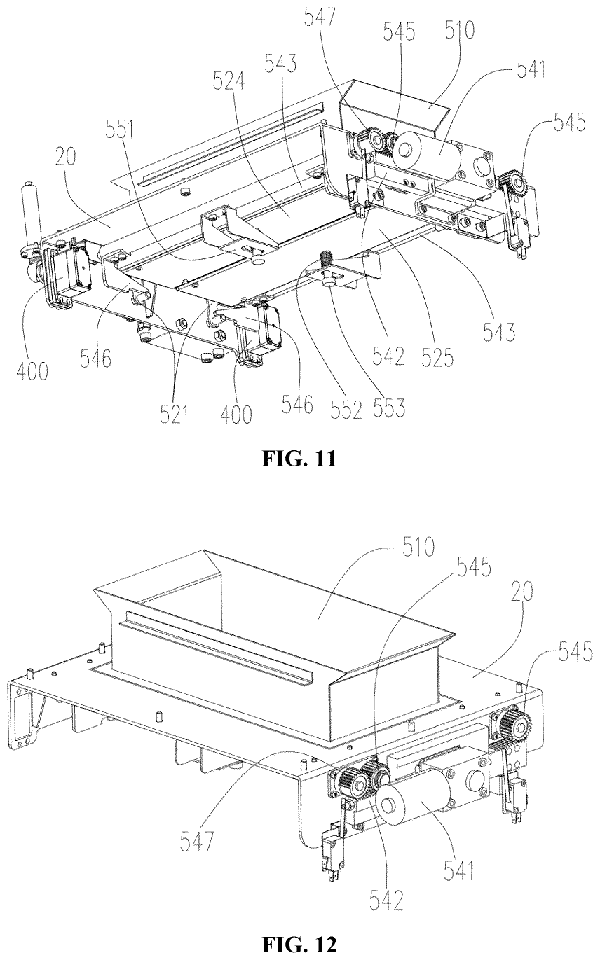

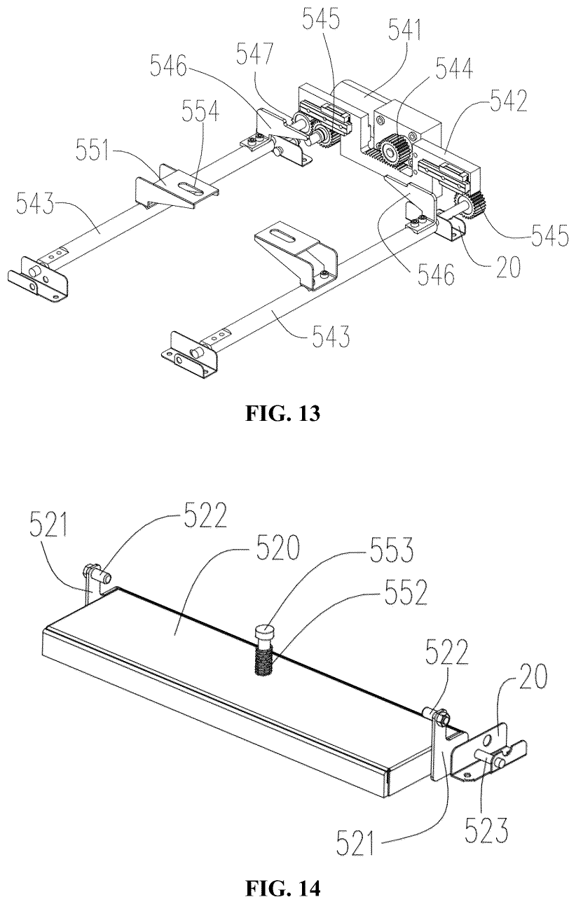

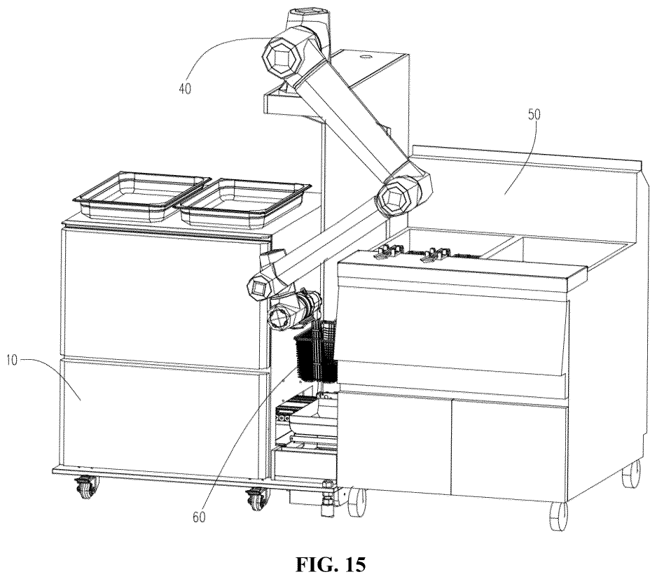

Referring to FIGS. 1, 2, 3, 4, 5, 6, 7, 8, 9, 10, 11, 12, 13, 14, and 15, the embodiment provides a desktop food distribution device, including a housing 10, a carrying platform 20, a storage bin assembly 100, a bin carrying member 200, a weighing assembly 300, and lift assemblies 400, wherein the carrying platform 20 is arranged in the housing 10; the weighing assembly 300 is arranged above the carrying platform 20; the lift assemblies 400 are arranged on the carrying platform 20; the lift assemblies 400 are located on an outer side of the weighing assembly 300; the lift assemblies 400 are connected to a bottom of the bin carrying member 200; the bin carrying member 200 is located above the weighing assembly 300; the storage bin assembly 100 is arranged on the bin carrying member 200; and the lift assemblies 400 can drive the bin carrying member 200 to move vertically, so that the bin carrying member 200 can detach from the weighing assembly 300.

Specifically, when using the desktop food distribution device, the staff pour the frozen food into the storage bin assembly 100, or the staff remove the storage bin assembly 100 for maintenance. During the process, it is easy to damage the load cells 310 of the weighing assembly 300. By providing the lift assemblies 400, the lift assemblies 400 are used to lift the bin carrying member 200 before operating the storage bin assembly 100, so that the storage bin assembly 100 located on the bin carrying member 200 detaches from the weighing assembly 300, so as to reduce the impact damage of the storage bin assembly 100 on the weighing assembly 300, thereby increasing the service life of the load cells 310.

It should be noted that the desktop food distribution device provided by the embodiment is of a desktop structure, which can effectively reduce the height of the desktop food distribution device, so that the top of the housing 10 can be used as an operation platform, and the user can utilize the space above the housing 10.

Additionally, the desktop food distribution device provided by the embodiment can be used in conjunction with a robot 40. The robot 40 can move a mesh basket containing food into a frying device 50 for frying. The mesh basket is located below the housing 10, and the mesh basket is located below the door switching assembly 500.

Referring to FIG. 1-FIG. 15, in an optional embodiment of the embodiment, the weighing assembly 300 includes a plurality of load cells 310; the plurality of load cells 310 are arranged on the carrying platform 20; and the bin carrying member 200 includes a support frame 210, and a bin carrying platform 220 configured for carrying the storage bin assembly 100, wherein the bin carrying platform 220 is arranged on the support frame 210; the support frame 210 is arranged on the plurality of load cells 310; the support frame 210 is provided with a weighing push rod 211 capable of abutting against the load cells 310; a plurality of lift assemblies 400 are connected to a bottom of the support frame 210; and the lift assemblies 400 can lift the support frame 210 away from the load cells 310.

Specifically, a weighing push rod 211 is arranged on the support frame 210, and the weighing push rod 211 can press against the load cells 310, so that the load cells 310 can measure the weight of the support frame 210 and the devices thereon. During food distribution, the food in the storage bin body 110 will be discharged downward. At this time, the load cells 310 can detect a decrease in weight, so as to control the amount of discharge.

Referring to FIG. 1-FIG. 15, in an optional embodiment of the embodiment, each of the lift assemblies 400 includes a lift driving member 410 and a lift push rod 420; the lift driving member 410 is arranged on the carrying platform 20; the lift push rod 420 is in transmission connection with the lift driving member 410; and the lift push rod 420 is connected to a bottom of the support frame 210. The lift driving member 410 includes a lift motor 411, a lift transmission member 412, and a lift guide sleeve 413; the lift motor 411 is mounted on the carrying platform 20; the lift transmission member 412 is arranged on an output end of the lift motor 411; the lift transmission member 412 is in transmission connection with the lift push rod 420; the lift guide sleeve 413 is arranged in the carrying platform 20; the lift push rod 420 is inserted in the lift guide sleeve 413; one end of the lift push rod 420 away from the lift transmission member 412 can pass through the lift guide sleeve 413 to connect to a bottom of the support frame 210; and the lift motor 411 is provided with a lift motor mounting plate 414, and the lift motor mounting plate 414 is arranged on the carrying platform 20.

A lift reset spring 415 is arranged between the lift push rod 420 and the lift guide sleeve 413; the lift reset spring 415 is sleeved on the lift push rod 420; and the lift push rod 420 is provided with a step abutting against the lift reset spring 415. The lift transmission member 412 includes a lift cam 416; the lift cam 416 is arranged on the output end of the lift motor 411; and the lift cam 416 abuts against the lift push rod 420.

Specifically, when it needs to lift the storage bin body 110, the lift motor 411 starts to operate, and the lift motor 411 can drive the lift cam 416 to rotate. The rotation of the lift cam 416 can drive the lift push rod 420 to move up and down, wherein the upward/downward movement of the lift push rod 420 is constrained by the lift guide sleeve 413, so as to ensure that the the lift push rod 420 moves upward/downward. The lifting of the lift push rod 420 can drive the support frame 210 to move upward, and the upward movement of the support frame 210 can drive the bin carrying platform 220 and the storage bin body 110 thereon to move upward, so that the load cells 310 are no longer pressed by the weighing push rod 211 on the bottom of the support frame 210. Then, the staff can perform operations such as adding food or cleaning on the storage bin body 110.

In addition, a lift reset spring 415 is arranged between the lift push rod 420 and the lift guide sleeve 413. By providing the lift reset spring 415, the lift push rod 420 can be always in contact with the lift cam 416.

Referring to FIG. 1-FIG. 15, in an optional embodiment of the embodiment, the desktop food distribution device further includes a door switching assembly 500; the door switching assembly 500 is arranged on the carrying platform 20; and the door switching assembly 500 is located below the weighing assembly 300. The door switching assembly 500 includes a food temporary-storage box 510, a switching door 520, and a switching driving assembly 530, wherein the food temporary-storage box 510 is arranged above the carrying platform 20, one end of the switching door 520 is pivotally connected to a bottom of the carrying platform 20, and the other end is in transmission connection with the switching driving assembly 530. The switching driving assembly 530 includes a switching driving member 540 and a switching closing member 550, wherein the switching driving member 540 is arranged on the carrying platform 20; the switching closing member 550 is arranged on the switching driving member 540; and the switching closing member 550 is connected to the switching door 520. A switching adapter plate 521 is fixedly arranged on an end part of the switching door 520, one end of the switching adapter plate 521 is pivotally connected to the carrying platform 20, and the other end is provided with a switching rotation stop pin 522. The switching rotation stop pin 522 is in transmission connection with the switching driving member 540, so that the switching rotation stop pin 522 can drive the switching door 520 to rotate under driven of the switching adapter plate 521. The switching adapter plate 521 is provided with a switching rotation pin 523, the switching rotation pin 523 is rotatably arranged on the carrying platform 20, and the switching adapter plate 521 is in L-shape.

Specifically, when the storage bin body 110 of the desktop food distribution device discharges the food, the switching driving member 540 of the switching driving assembly 530 opareats, driving the switching closing member 550 and the switching door 520 to rotate to open the bottom of the food temporary-storage box 510. Therefore, the food in the storage bin body 110 above can be discharged downwardly by the food temporary-storage box 510. After the discharge is completed, the switching driving member 540 drives the switching closing member 550 and the switching door 520 to reset. During the reset process, the switching closing member 550 can tightly abut against the bottom of the switching door 520, so that the switching door 520 tightly abuts against the food temporary-storage box 510, thereby ensuring that the switching door 520 is tightly closed and will not leak the cold air in the above area.

In addition, the switching door 520 is pivotally connected to the carrying platform 20 by the L-shaped switching adapter plate 521, wherein a switching rotation pin 523 rotationally connected to the carrying platform 20 is arranged on one end of the L-shaped switching adapter plate 521, and a switching rotation stop pin 522 is arranged on the other end. The switching rotation stop pin 522 can abut against the switching toggle rod 546 of the switching driving member 540. Thus, when the switching driving member 540 operates to drive the swing of the switching toggle rod 546, the switching toggle rod 546 can drive the switching rotation pin 523 to swing, so as to drive the switching door 520 to rotate.

Referring to FIG. 1-FIG. 15, in an optional embodiment of the embodiment, the above switching driving member 540 includes a switching motor 541, a switching rack 542, and a switching drive shaft 543, wherein the switching motor 541 is arranged on the carrying platform 20; the switching rack 542 is slidably arranged on the carrying platform 20; an output end of the switching motor 541 is provided with a first switching driving gear 544 adapted to the switching rack 542; the switching drive shaft 543 is rotatably arranged on the carrying platform 20; an end part of the switching drive shaft 543 is provided with a second switching driving gear 545 adapted to the switching rack 542; the switching drive shaft 543 is provided with a switching toggle rod 546; the switching toggle rod 546 abuts against the switching rotation stop pin 522; the switching drive shaft 543 includes a first switching drive shaft 543 and a second switching drive shaft 543; the switching door 520 includes a first switching door 524 and a second switching door 525; the first switching drive shaft 543 and the second switching drive shaft 543 respectively correspond to the first switching door 524 and the second switching door 525; the first switching drive shaft 543 and the second switching drive shaft 543 are both provided with the second switching driving gear 545; and a slave turning switching gear 547 is arranged between the second switching driving gear 545 of the first switching drive shaft 543 and the switching rack 542.

Specifically, the switching motor 541 can drive the first switching driving gear 544 to rotate, and the first switching driving gear 544 can drive the switching rack 542 to move. The switching rack 542 moves, and is capable of directly driving, or during through the slave turning switching gear 547, the second switching driving gear 545 arranged on both the first switching drive shaft 543 and the second switching drive shaft 543, so as to drive both the first switching drive shaft 543 and the second switching drive shaft 543 to rotate. The rotation of both the first switching drive shaft 543 and the second switching drive shaft 543 can drive the switching toggle rod 546 thereon to swing, and the swing of the switching toggle rod 546 can drive the switching rotation pin 523 to swing, thereby driving the switching door 520 to rotate.

Referring to FIG. 1-FIG. 15, in an optional embodiment of the embodiment, the switching closing member 550 includes a switching pressure plate 551, a switching compression spring 552, and a switching compression spring bolt 553, wherein the switching pressure plate 551 is fixedly arranged on the switching drive shaft 543; the switching pressure plate 551 is provided with a switching waist slot 554; the switching compression spring bolt 553 is arranged in the switching waist slot 554; the switching compression spring bolt 553 is connected to a bottom of the switching door 520; the switching compression spring 552 is sleeved on the switching compression spring bolt 553; one end of the switching compression spring 552 abuts against the switching door 520; and the other end abuts against the switching pressure plate 551.

Specifically, the switching pressure plate 551 is fixedly arranged on the switching drive shaft 543; the switching compression spring bolt 553 is arranged in the switching waist slot 554 of the switching pressure plate 551; and the switching compression spring bolt 553 is screwed into the bottom of the switching door 520. A switching compression spring 552 is sleeved on the switching compression spring bolt 553, wherein one end of the switching compression spring 552 abuts against the switching door 520, and the other end abuts against the switching pressure plate 551. After the switching drive shaft 543 drives the switching door 520 to be reset, the switching compression spring 552 on the switching compression spring bolt 553 tightly abuts between the bottom of the switching door 520 and the switching pressure plate 551, so as to ensure that the switching door 520 is closed tightly.

Referring to FIG. 1-FIG. 15, in an optional embodiment of the embodiment, the storage bin assembly 100 includes a storage bin body 110 and a discharge wheel 120; the storage bin body 110 is detachably mounted on the bin carrying member 200; an inlet port 111 is arranged on the top of the storage bin body 110; an outlet port 112 is arranged on a bottom of the storage bin body 110; the bin carrying platform 220 is provided with a drop port 221 corresponding to the outlet port 112; and the support frame 210 is provided with a discharge power member 30. The discharge power member 30 can be connected to the discharge wheel 120 in a transmission manner, and the discharge power member 30 is detachably connected to the discharge wheel 120. The discharge wheel 120 is arranged in the storage bin body 110; two ends of the discharge drive shaft 130 of the discharge wheel 120 are arranged to penetrate through side walls of the storage bin 110; one end of the discharge drive shaft 130 is provided with a discharge abutting port 131 that can be adapted to the discharge power member 30; the other end of the discharge drive shaft 130 is provided with a correction knob 132; and an angle of the discharge abutting port 131 can be adjusted by rotating the correction knob 132, so as to butt with the discharge power member 30.

Specifically, during use, the staff can pull out the storage bin assembly 100 from the housing body 10, and then the food is conveniently poured into the storage bin assembly 100. After that, the staff can place the storage bin assembly 100 into the housing body 10, so that the storage bin assembly 100 and the discharge power member 30 in the housing body 10 are connected together. Through such arrangement, it is convenient for the staff to fill the food into the storage bin assembly 100, and it is also convenient for cleaning the storage bin assembly 100.

Referring to FIG. 1-FIG. 15, in an optional embodiment of the embodiment, the discharge power member 30 includes a discharge driving motor 31 and a discharge output shaft 32, wherein the discharge driving motor 31 is arranged on the support frame 210; the discharge output shaft 32 is in transmission connection with the discharge driving motor 31; the discharge output shaft 32 can be connected to the discharge drive shaft 130 in a transmission manner; and a discharge driving plug 33 for adapting to the discharge abutting port 131 is arranged on a front end of the discharge output shaft 32.

Specifically, the discharge wheel 120 is sleeved on the discharge drive shaft 130; two ends of the discharge drive shaft 130 pass through the side walls of the storage bin body 110; and the discharge abutting port 131 is arranged on one end of the discharge drive shaft 130 connecting to the discharge power member 30. The discharge driving plug 33 is arranged on the discharge output shaft 32 of the discharge driving motor 31, and the discharge driving plug 33 can be inserted in the discharge abutting port 131, so that the storage bin body 110 can be detachably connected to the bin carrying member 200. Moreover, after the storage bin body 110 is mounted to the bin carrying member 200, it can ensure that the discharge driving motor 31 can drive the discharge wheel 120 inside the storage bin body 110 to rotate.

In addition, a correction knob 132 is arranged on one end of the discharge drive shaft 130 away from the discharge abutting port 131, and the staff member can manually turn the correction knob 132 to adjust the angle of the discharge abutting port 131. Therefore, during the process of loading back the storage bin body 110, the staff member can adjust the angle of the discharge abutting port 131 by turning the correction knob 132, so that the discharge abutting port 131 is smoothly docked with the discharge driving plug 33.

The bin carrying platform 220 is arranged on the support frame 210, and the bin carrying platform 220 can carry the storage bin assembly 100 to ensure the stability of the storage bin assembly 100. The bin carrying platform 220 is provided with a drop port 221 corresponding to the outlet port 112. After the storage bin assembly 100 is mounted to the bin carrying platform 220, the outlet port 112 at the bottom of the storage bin body 110 can correspond to the drop port 221, so as to ensure the smooth descent of the food.

It is to be noted that inclined support platforms 222 are arranged on two sides of the bin carrying platform 220 located at the drop port 221. The two inclined support platforms 222 are provided to provide guidance for the movement of the storage bin body 110, thereby making it more convenient for the staff to dock the discharge abutting port 131 on the storage bin body 110 with the discharge driving plug 33 of the discharge power member 30.

It is further noted that a bin limit stop pin 223 is arranged on one end of the inclined support platform 222 away from the discharge power member 30, and the bin limit stop pin 223 is inserted in the inclined support platform 222. When it needs to disassemble the storage bin body 110, the staff can pull out the bin limit stop pin 223, and then disassemble the storage bin body 110. After filling the food into the storage bin body 110 and the storage bin body 110 is remounted, the staff can reinsert the bin limit stop pin 223 into the inclined support platform 222. The bin limit stop pin 223 can limit the storage bin body 110 to avoid the movement of the storage bin body 110 due to vibration and other reasons during operation, which ensures the normal transmission between the storage bin body 110 and the discharge driving motor 31.

Referring to FIG. 1-FIG. 15, in an optional embodiment of the embodiment, a flexible baffle 113 is arranged on a side wall of the storage bin body 110; the flexible baffle 113 is arranged on two sides of the discharge wheel 120; and the discharge wheel 120 and the flexible baffle wheel 113 divide an internal space of the storage bin body 110 into a storage region 101 and a discharge region 102; the side wall of the storage bin body 110 is provided with a baffle through hole 114 for the flexible baffle 113 to pass through; the side wall of the storage bin body 110 is provided with a recessed baffle mounting base 115; and the baffle through hole 114 is arranged in the baffle mounting base 115, so that an extension direction of the flexible baffle 113 faces toward the discharge wheel 120.

Specifically, during a downward discharging process of the frozen food, the frozen food is piled up in the storage region 101, and the frozen food will be filled between the side wall of the storage bin body 110 and the discharge wheel 120. When the discharge wheel 120 rotates, the frozen food on the discharge wheel 120 will fall down with the discharge wheel 120 between the discharge wheel 120 and the flexible baffle plate 113, and then be discharged from the outlet port 112 at the bottom of the storage bin body 110. When the frozen food is located between the discharge wheel 120 and the flexible baffle 113, the flexible baffle 113 can be opened by the support of the frozen food, which prevents the frozen food from being crushed by the discharge wheel 120 and the flexible baffle 113, thereby reducing the damage rate of the frozen food.

The bottom of the storage bin body 110 is designed in a funnel shape, which ensures that the frozen food falling from the storage region 101 to the discharge region 102 can be smoothly discharged from the outlet port 112 at the bottom of the storage bin body 110.

A plurality of reinforcement bars are arranged on the side wall of the storage bin body 110. By providing the reinforcement bars, the overall strength of the storage bin body 110 is improved.

In addition, the flexible baffle 113 can be a rubber baffle. The person skilled in the art may also choose the material of the flexible baffle 113 according to the actual needs, which will not be repeated herein.

The discharge wheel 120 is provided with a plurality of groups of discharge toggle teeth arranged in a staggered manner. By this arrangement, the frozen food in the storage bin body 110 can be toggled more effectively. The discharge toggle teeth can contact the flexible baffle 113 when rotating with the discharge wheel 120. By this arrangement, the lower part of the storage bin body 110 can be sealed by the discharge wheel 120 and the flexible baffle 113, which prevents the frozen food from falling from the storage region 101 to the discharge region 102.

It is to be noted that the side wall of the storage bin body 110 is provided with a baffle through hole 114 for the flexible baffle 113 to pass through. Both the first flexible baffle 113 and the second flexible baffle 113 pass through the baffle through hole 114 on the side wall of the storage bin body 110, and then are arranged into the storage bin body 110. By this arrangement, it is easy for the staff to replace the first flexible baffle 113 and the second flexible baffle 113.

The side wall of the storage bin body 110 is provided with a recessed baffle mounting base 115, and the baffle through hole 114 is arranged in the baffle mounting base 115, so that an extension direction of the flexible baffle 113 faces toward the discharge wheel 120. The baffle mounting base 115 arranged on the side wall of the storage bin body 110 can enhance the structural strength of the storage bin body 110.

Finally, it should be noted that the above embodiments are only used to illustrate the technical solutions of the present disclosure, and not to restrict it. Although the present disclosure is described in detail with reference to the foregoing embodiments, it should be understood by persons of ordinary skill in the art that they may still modify the technical solutions described in the foregoing embodiments or make equivalent substitutions for some or all of the technical features; and these modifications or substitutions do not take the essence of the corresponding technical solutions out of the scope of the technical solutions in each embodiment of the present disclosure.

1. A desktop food distribution device, comprising: a housing, a carrying platform, a storage bin assembly, a bin carrying member, a weighing assembly, and lift assemblies, wherein
the carrying platform is arranged in the housing, and the weighing assembly is arranged on the carrying platform; and
the lift assemblies are arranged on the carrying platform; the lift assemblies are located on an outer side of the weighing assembly; the lift assemblies are connected to a bottom of the bin carrying member; the bin carrying member is located above the weighing assembly; and the storage bin assembly is arranged on the bin carrying member; and the lift assemblies are allowed to drive the bin carrying member to move upward/downward, wherein the bin carrying member is allowed for being detached from the weighing assembly.

2. The desktop food distribution device according to claim 1, wherein the weighing assembly comprises a plurality of load cells; the plurality of load cells are arranged on the carrying platform; and
the bin carrying member comprises a support frame, and a bin carrying platform for carrying the storage bin assembly, the bin carrying platform is arranged on the support frame, and the support frame is arranged on the plurality of load cells; the support frame is provided with a weighing push rod allowed for abutting against the load cells; a plurality of lift assemblies are connected to a bottom of the support frame; and the lift assemblies are allowed to lift the support frame away from the load cells.

3. The desktop food distribution device according to claim 2, wherein each of the lift assemblies comprises a lift driving member and a lift push rod; the lift driving member is arranged on the carrying platform; the lift push rod is in transmission connection with the lift driving member; and the lift push rod is connected to a bottom of the support frame;
the lift driving member comprises a lift motor, a lift transmission member, and a lift guide sleeve; the lift motor is mounted on the carrying platform; the lift transmission member is arranged on an output end of the lift motor; the lift transmission member is in transmission connection with the lift push rod; the lift guide sleeve is arranged in the carrying platform; the lift push rod is inserted in the lift guide sleeve; and one end of the lift push rod away from the lift transmission member is allowed for passing through the lift guide sleeve to connect to the bottom of the support frame; and
the lift motor is provided with a lift motor mounting plate, and the lift motor mounting plate is arranged on the carrying platform.

4. The desktop food distribution device according to claim 3, wherein a lift reset spring is arranged between the lift push rod and the lift guide sleeve; the lift reset spring is sleeved on the lift push rod; and the lift push rod is provided with a step abutting against the lift reset spring; and
the lift transmission member comprises a lift cam; the lift cam is arranged on the output end of the lift motor; and the lift cam abuts against the lift push rod.

5. The desktop food distribution device according to claim 1, further comprising a door switching assembly, wherein the door switching assembly is arranged on the carrying platform;
the door switching assembly is located below the weighing assembly; and the door switching assembly comprises a food temporary-storage box, a switching door, and a switching driving assembly;
the food temporary-storage box is arranged above the carrying platform; a first end of the switching door is pivotally connected to a bottom of the carrying platform, and a second end of the switching door is in transmission connection with the switching driving assembly;
the switching driving assembly comprises a switching driving member and a switching closing member, wherein the switching driving member is arranged on the carrying platform;
the switching closing member is arranged on the switching driving member; and the switching closing member is connected to the switching door;
a switching adapter plate is fixedly arranged on an end part of the switching door; a first end of the switching adapter plate is pivotally connected to the carrying platform, and a second end of the switching adapter is provided with a switching rotation stop pin; the switching rotation stop pin is in transmission connection with the switching driving member, wherein the switching rotation stop pin is allowed to drive the switching door to rotate under a driven of the switching adapter plate; and
the switching adapter plate is provided with a switching rotation pin; the switching rotation pin is rotatably arranged on the carrying platform; and the switching adapter plate is in L-shape.

6. The desktop food distribution device according to claim 5, wherein the switching driving member comprises a switching motor, a switching rack, and a switching drive shaft, wherein
the switching motor is arranged on the carrying platform; the switching rack is slidably arranged on the carrying platform; an output end of the switching motor is provided with a first switching driving gear adapted to the switching rack; the switching drive shaft is rotatably arranged on the carrying platform; an end part of the switching drive shaft is provided with a second switching driving gear adapted to the switching rack;
the switching drive shaft is provided with a switching toggle rod; the switching toggle rod abuts against the switching rotation stop pin; and
the switching drive shaft comprises a first switching drive shaft and a second switching drive shaft; the switching door comprises a first switching door and a second switching door;
the first switching drive shaft and the second switching drive shaft respectively correspond to the first switching door and the second switching door; the first switching drive shaft and the second switching drive shaft are both provided with the second switching driving gear; and a slave turning switching gear is arranged between the second switching driving gear of the first switching drive shaft and the switching rack.

7. The desktop food distribution device according to claim 6, wherein the switching closing member comprises a switching pressure plate, a switching compression spring, and a switching compression spring bolt, wherein
the switching pressure plate is fixedly arranged on the switching drive shaft; the switching pressure plate is provided with a switching waist slot; and the switching compression spring bolt is arranged in the switching waist slot; and
the switching compression spring bolt is connected to a bottom of the switching door; the switching compression spring is sleeved on the switching compression spring bolt; and a first end of the switching compression spring abuts against the switching door, and a second end of the switching compression spring abuts against the switching pressure plate.

8. The desktop food distribution device according to claim 2, wherein the storage bin assembly comprises a storage bin body and a discharge wheel; the storage bin body is detachably mounted on the bin carrying member; an inlet port is arranged on a top of the storage bin body; an outlet port is arranged on a bottom of the storage bin body; the bin carrying platform is provided with a drop port corresponding to the outlet port;
the support frame is provided with a discharge power member, wherein the discharge power member is in transmission connection with the discharge wheel, and the discharge power member is detachably connected to the discharge wheel; and
the discharge wheel is arranged in the storage bin body; two ends of a discharge drive shaft of the discharge wheel are arranged to penetrate through side walls of the storage bin body; a first end of the discharge drive shaft is provided with a discharge abutting port that is allowed to be adapted to the discharge power member, and a second end of the discharge drive shaft is provided with a correction knob; and an angle of the discharge abutting port is adjusted by rotating the correction knob to dock with the discharge power member.

9. The desktop food distribution device according to claim 8, wherein the discharge power member comprises a discharge driving motor and a discharge output shaft, wherein
the discharge driving motor is arranged on the support frame; the discharge output shaft is in transmission connection with the discharge driving motor; the discharge output shaft is in transmission connection with the discharge drive shaft; and a discharge driving plug for adapting to the discharge abutting port is arranged on a front end of the discharge output shaft.

10. The desktop food distribution device according to claim 9, wherein flexible baffles are arranged on the side wall of the storage bin body; the flexible baffles are arranged on two sides of the discharge wheel; and the discharge wheel and a flexible baffle wheel divide an internal space of the storage bin body into a storage region and a discharge region; and
the side wall of the storage bin body is provided with a baffle through hole for the flexible baffles to pass through; the side wall of the storage bin body is provided with a recessed baffle mounting base; and the baffle through hole is arranged on the recessed baffle mounting base, wherein an extension direction of the flexible baffle faces toward the discharge wheel.
